(19) United States
(12) Patent Application Publication
(10) Pub. No.: US 2012/0310431 A1
(43) Pub. Date: Dec. 6, 2012

(54) SYSTEM AND METHOD FOR SELECTING CONSUMERS FOR DEMAND RESPONSE

(75) Inventors: William Estel Cheetham, Clifton Park, NY (US); Jason Wayne Black, Clifton Park, NY (US); Jesse Neuendank Schechter, Niskayuna, NY (US)

(73) Assignee: GENERAL ELECTRIC COMPANY, SCHENECTADY, NY (US)

(21) Appl. No.: 13/118,753

(22) Filed: May 31, 2011

(51) Int. Cl. G06F 1/26

(52) U.S. Cl. 700/295

(57) ABSTRACT

A method for selecting consumers is presented. The method comprises the steps of receiving consumers' data, historical response data, contractual obligations data of a plurality of consumers; receiving a demand response event's description data, determining at least one parameter corresponding to each of the plurality of consumers based upon one or more of the consumers' data, the historical response data, the contractual obligations data and the demand response event's description data, and selecting a subset of consumers from the plurality of consumers based upon the at least one parameter, wherein the at least one parameter comprises a potential load reduction for each of the plurality of consumers.

### BACKGROUND

In an electric utility grid, electricity consumption and production must balance at all times. A significant imbalance may cause instability, severe voltage fluctuations, certain other failures and blackouts. Therefore, infrastructure of the utility grid and electricity generation is typically sized to correspond to acceptable electricity demand limits. However, sometimes a peak demand of electricity may be higher than the acceptable electricity demand limit. In such instances, the utility grid and respective existing infrastructure may not be able to meet electricity demands of consumers. Demand response is one of the techniques to address such excess electricity demand issues. Demand response includes mechanisms that are used to encourage/induce utility consumers to curtail or shift their demand at particular times in order to reduce aggregate electricity demand.

Utility grids may execute demand response events to reduce electricity demand for required durations. The execution of demand response events typically includes load shedding by respective consumers or forced load shedding by the utility grids. The utility grids may offer incentives to respective consumers for agreeing to reduce their electricity consumption for specified durations. However, all respective consumers may not be required to reduce their electricity demand in all demand response events. Additionally, certain consumers may be more appropriate for reduction of electricity demand in comparison to others.

For these and other reasons, there is a need for embodiments of the present invention.

### BRIEF DESCRIPTION

A method for selecting consumers is presented. The method includes receiving consumers' data, historical response data, contractual obligations data of a plurality of consumers, receiving a demand response event's description data, determining at least one parameter corresponding to each of the plurality of consumers based upon one or more of the consumers' data, the historical response data, the contractual obligations data and the demand response event's description data, and selecting a subset of consumers from the plurality of consumers based upon the at least one parameter, wherein the at least one parameter comprises a potential load reduction for each of the plurality of consumers.

### DRAWINGS

These and other features and aspects of embodiments of the present invention will become better understood when the following detailed description is read with reference to the accompanying drawings in which like characters represent like parts throughout the drawings, wherein:

FIG. 1 is a block diagram of an exemplary system that selects consumers to reduce electricity consumption for a specified duration;

FIG. 2 is a flowchart representing an exemplary method for generating and maintaining a database that may be used for selection of consumers to reduce electricity consumption in a specified duration;

FIG. 3 is a flowchart representing an exemplary method for selecting appropriate consumers for execution of a demand response event, in accordance with aspects of the present techniques; and

FIG. 4 is a flowchart representing an exemplary method for selecting one or more groups of appropriate consumers for execution of a demand response event, in accordance with aspects of the present techniques.

### DETAILED DESCRIPTION

Execution of demand response events includes reduction of electricity consumption by consumers, or forced load shedding by an electric utility. The electric utility may not need all consumers for execution of such demand response events. For example, the electric utility may involve one or more consumers who are available at certain durations, and have high consumption of electricity. Also, the electric utility may not select too many consumers in a single demand response event. For example, if too many consumers are selected for the execution of a single demand response event, then a reduced number of consumers may be available for the execution of future demand response events. Therefore, it may be necessary or beneficial to select a subset of consumers for the execution of each demand response event. Hereinafter, the terms “subset of consumers” and “appropriate consumers” will be used interchangeably. As used herein, the term “appropriate consumer” may be used to refer to a consumer who is optimally suitable for reduction of energy usage in a demand response event. For example, in summers one or more consumers who are available and have air conditioners may be suitable for reduction of energy usage in specific durations.

As discussed in detail below, embodiments of the present systems and techniques select the appropriate consumers for an efficient execution of a demand response event. Particularly, embodiments of the present systems and methods select appropriate consumers for reduction of electricity consumption in a specified duration. Certain embodiments of the present systems and methods select the appropriate consumers such that the cost of utilizing the appropriate consumers and/or rebound effect after execution of a demand response event is optimal. Certain other embodiments select the appropriate consumers to maintain equitable rotation amongst an electric utility's consumers. Furthermore, alternative embodiments select appropriate consumers such that a probability of availability of the appropriate consumers is as required. In certain other embodiments, the appropriate consumers are selected after considering a potential decay in reduction of electricity usage by consumers during execution of a demand response event. In alternative embodiments, the appropriate consumers are selected based upon variation in electricity usage of consumers due to varied atmospheric temperature. Certain embodiments of the present systems and methods select a group of appropriate consumers who may reduce energy in a specified time. Hereinafter, the terms “energy” and “electricity” will be used interchangeably.

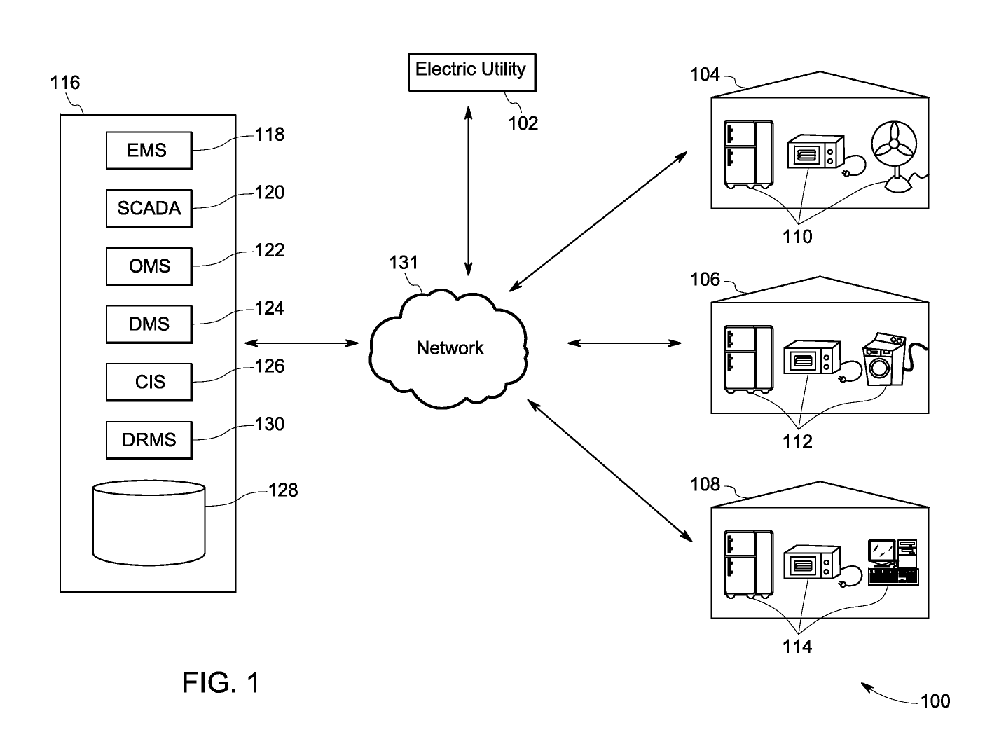

FIG. 1 is a block diagram of an exemplary system 100 that selects consumers for reduction of electricity consumption for a specified duration. The system 100 includes an electric utility 102 that provides electricity to a plurality of consumers 104, 106, 108. In the presently contemplated configuration, each of the consumers 104, 106, 108 is under a contractual obligation with the electric utility 102 to reduce electricity consumption in specified durations. The contractual obligation, for example, may be for reducing electricity consumption in specified durations or buying electricity at a higher price. As shown in FIG. 1, each of the consumers 104, 106, 108 may own one or more appliances 110, 112, 114, respectively. The appliances 110, 112, 114, for example, may include a refrigerator, an air conditioner, a washing machine, commercial machines, and other devices that operate on electricity. The consumers 104, 106, 108 may use electricity for operating the appliances 110. 112, 114. Therefore, a total consumption of electricity by each of the consumers 110, 112, 114 may vary based upon a number and nature of respective appliances, consumers' lifestyle and atmospheric temperature, for example.

In certain embodiments, the utility 102 may include a control center 116. The control center 116 may include an Energy Management System (EMS) 118 that performs load forecasting, and monitors, controls, and optimizes the performance of electricity generation and transmission systems. A Supervisory Control And Data Acquisition (SCADA) 120 provides real time information at different points in the electric utility 102 and also provides local controls. An Outage Management System (OMS) 122 monitors load status information and outage restoration information. Some of the functions performed by the OMS 122 may include failure prediction, providing information on the extent of outages and impact to the consumers 104, 106, 108, and prioritizing restoration efforts. Furthermore, a Distribution Management System (DMS) 124 provides real-time response to adverse or unstable network conditions by providing information on load status and load response. A Demand Response Management System (DRMS) 130 is used to initiate demand response events to reduce or curtail load through price or direct control signals from the utility to the consumer devices. Consumer information, such as, consumers' data, contractual obligations data, responses of the consumers 104, 106, 108 to load shed requests, and the like is monitored and controlled by a Consumer Information System (CIS) 126. The control center 116 also includes a data storage unit 128 for storing data such as historical data for each consumer 104, 106, 108 in the distribution network based on information from the EMS 118, SCADA 120, OMS 122, DMS 124, DRMS 130, and CIS 126, for example. The historical data may include information on consumer utility usage including load type, time of use (TOU), duration of use, shed or demand response events, for example. The consumer usage information stored in the data storage unit 128 can be updated periodically (e.g., hourly, daily) with load data including hourly load and hourly price over a twenty four hour period, environmental data including weather information (temperature, humidity, wind speed, heating and cooling degrees) and date and time information such as day of the week, season, etc. In addition, the data storage unit 128 stores event data for each of the consumers 104, 106, 108. More specifically, the data storage unit 128 stores historical information on whether a consumer participated in a demand response event, the start time and end time, day of week, season, etc.

Communication between the consumers 104, 106, 108, control center 116, DRMS 130, and the electric utility 102 can occur via a WAN (e.g., Internet) 106, WiMAX, broadband, AMI, and/or power line carriers, for example. Communication can also occur via a private network. Any suitable means for communication can be used. The control center 116 can be arranged at and/or hosted by the utility 102 and/or by any other party. The DRMS 130 can be arranged at the control center or some other location and can be hosted by the utility 102 and/or by any other party.

For optimal management of electricity demands, the electric utility 102 may execute one or more demand response events. The execution of the demand response events, for example, may involve requesting one or more of the consumers 104, 106, 108 to reduce electricity consumption in specified durations. However, due to various reasons, each of the consumers 104, 106, 108 may not be required to reduce electricity consumption. The reasons, for example, may include non-availability of a consumer, less usage of appliances by a consumer in a specified duration, contribution to a high number of demand response events in the past, exhausted a total number of demand response events mentioned in a contract with the electric utility 102, and the like. Therefore, execution of demand response events entails selection of the appropriate consumers from the consumers 104, 106, 108. In the presently contemplated configuration, a processing subsystem 130, such as the DRMS 130, selects the appropriate consumers from the consumers 104, 106, 108 for the execution of one or more demand response events in a specified duration.

In one embodiment, the electric utility 102 may transmit a demand response event's description data to the DRMS 130. As used herein, the term “demand response event's description data” may be used to refer to data related to a demand response event including a potential total amount of energy reduction, and time and duration of the demand response event, for example. The demand response event's description data, for example may include a start time and an end time for energy reduction, a potential total amount of energy reduction, a specified duration for energy usage reduction, forecasted atmospheric temperature, a region for energy usage reduction, and the like.

The processing subsystem or DRMS 130 receives the requirements of a demand response event from the electric utility 102. These requirements include the location, timing, and duration of necessary load reductions, for example. The DRMS 130 collects consumers' data, historical response data, Demand Response (DR) program parameters, and contractual obligations data from a plurality of sources. The sources, for example may include the CIS (126), historian database (128), electric utility 102, consumers 104, 106, 108, a SCADA 120, an EMS 118, weather forecasting departments (not shown), smart meters (not shown), control center 116, and the like. The DRMS 130 may collect various types of data, and communicate with different systems and the consumers 104, 106, 108 via network 131. As used herein, the term “consumers' data” may be used to refer to data related to consumers and details of respective appliances. For example, the consumers' data may include a unique identification of the consumers 104, 106, 108, details of the appliances 110, 112, 114, availability of the consumers 104, 106, 108, a number of demand response events contributed to for energy usage reduction, and a probability of responding to energy usage reduction requests. The term “historical response data” is used herein to refer to the details of events in which each of the consumers 104, 106, 108 were sent requests for reduction of energy usage, and response details of the consumers 104, 106, 108 to such requests. The historical response data, for example, may include a date and time of sending a request for reduction of energy usage in a demand response event, a unique ID of a consumer to whom the request was sent, date, time and duration of the demand response event, response to the request, a total number of demand response events in which the consumer participated, a rebound effect of the consumer after participating in each demand response event, a total number of demand response events in which the consumer refused to participate, and the like. Additionally, the term “contractual obligations data” is used herein to refer to data related to contracts between the consumers 104, 106, 108 and the electric utility 102 for execution of demand response events. The contractual obligations data, for example, may include a unique ID of a consumer who enters in to a contract with the electric utility 102, terms and conditions in the contract, a total number of events in which the consumer is expected to participate as per the contract, a cost of involving the consumer in the execution of a demand response event, and limits to the times and durations of such events.

As shown in FIG. 1, the processing subsystem or DRMS 130 may store the consumers' data, historical response data and contractual obligations data in the data repository 128. Furthermore, the DRMS 130 may update the consumers' data, historical response data and contractual obligations data periodically by collecting or receiving updates. Additionally, the DRMS 130 determines at least one parameter based upon the consumers' data, historical response data, contractual obligations data and demand response event's description data. The at least one parameter, for example may include a potential load reduction (PLR), an adjusted potential load reduction (APLR), an adjusted cost for involving each of the plurality of consumers 104, 106, 108 in a demand response event, and the like. As used herein, the term “potential load reduction” may be used to refer a potential total amount of energy usage reduction by a consumer that is normalized based upon consumers' data, historical response data, contractual obligations data and demand response event's description data. Furthermore, the term “adjusted potential load reduction” may be used herein to refer to a potential load reduction (PLR) that is adjusted based upon the historical response data. The term “adjusted cost” is used herein to refer to a cost of utilizing a consumer (for execution of a demand response event) that has been normalized utilizing the historical response data. The determination of the PLR, APLR and adjusted cost will be explained in greater detail with reference to FIG. 3. The DRMS 130 may select the appropriate consumers from the consumers 104, 106, 108 based upon the at least one parameter. More particularly, the processing subsystem 130 may select the appropriate consumers based upon at least one of the parameters including PLR, APLR and adjusted cost. The selection of the appropriate consumers will be explained in greater detail with reference to FIG. 3.

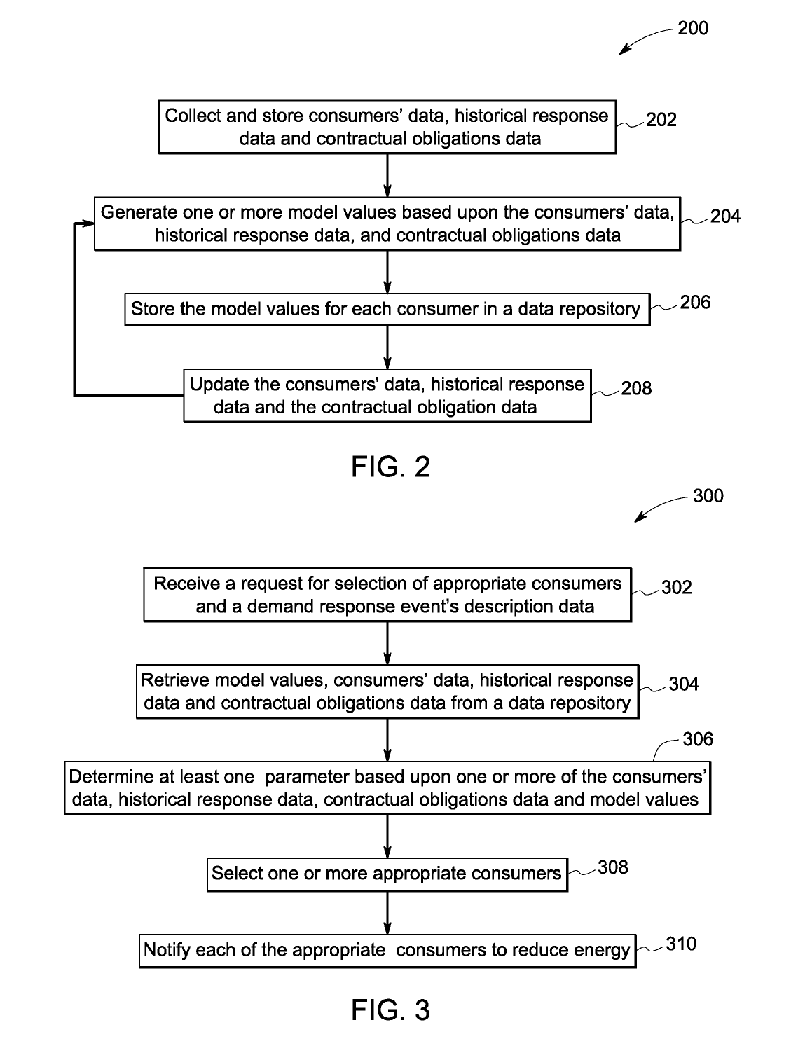

FIG. 2 is a flowchart representing an exemplary method 200 for generating and maintaining a database that may be used for selection of appropriate consumers, in accordance with an embodiment of the present system and techniques. In one example, at step 202, consumers' data, historical response data and contractual obligations data is collected and stored in the data repository 128. The consumers' data, historical response data and contractual obligations data may be collected by the electric utility 102, the DRMS 130 (see FIG. 1), and the like. Furthermore, at step 204, one or more model values corresponding to each of the consumers 104, 106, 108 may be generated. As used herein, the term “model values” may be used to refer to certain fixed values that are generated based upon consumers' data, historical response data and contractual obligations data, and are updated when one or more portions of the consumers' data, historical response data and contractual obligations data is updated.

The model values, for example, may include a total energy consumed by appliances of a consumer, predicted deviation in energy usage by the consumer (PU), event history (EH), a probability of responding to a request for reduction of energy usage, availability of the consumer, decay in reduction of energy usage by the consumer, rebound effect, temperature curve value, and the like. The model value “total energy consumed by appliances of a consumer,” for example, may be determined based upon the consumers' data which includes details of appliances with a consumer. It is noted that a total energy consumed by consumers may vary based upon time of usage, atmospheric temperature, lifestyle, and the like. Therefore, the total energy consumed by a consumer may have multiple values for different time periods. For example, a consumer may operate all appliances during evening hours on a hot day.

Furthermore, the model values may include the predicted deviation in energy usage by each of the consumers 104, 106, 108. As used herein, the term “predicted deviation in energy usage (PU)” is used to refer to a value that signifies a variation in energy usage of a consumer due to various factors. The factors, for example, may include atmospheric temperature, availability of consumer during specific hours, and the like. For example, if there is no variation in the energy usage of a consumer A, then the value of predicted deviation in energy usage is 1. However, when there is variation in the energy usage of the consumer A, then the value of the predicted deviation in energy usage may be less than 1. Additionally, the model value “probability of responding to a request for reduction of energy usage” and “availability of a consumer” corresponding to the consumers 104, 106, 108 may be determined based upon respective historical response data of the consumers 104, 106, 108.

As used herein, the model value “event history” is used to refer to a quotient of a remaining number of demand response events (RE) and a total number of demand response events (TE) in which a consumer is expected to participate. Accordingly, the event history corresponding to each of the consumers 104, 106, 108 may be determined using the following equation (1):

EH(Cᵢ)=RE(Cᵢ)/TE(Cᵢ) (1)

where EH(Cᵢ) is an event history corresponding to a consumer Cᵢ, RE(Cᵢ) is a remaining number of events in which the consumer Cᵢ is expected to participate, and TE(Cᵢ) is a total number of events in which the consumer Cᵢ is expected to participate. The total number of events TE(Cᵢ) in which a consumer is expected to participate, for example, may be determined utilizing contractual obligations data corresponding to the consumer. Additionally, the remaining number of events RE(Cᵢ) in which a consumer is expected to participate may be determined based upon historical response data corresponding to the consumer.

The model value “decay in energy usage reduction” is used herein to refer to a tendency of a consumer to decrease energy usage reduction during execution of a demand response event. More particularly, the decay in energy usage reduction may be used to refer to a percentage decrease in energy usage reduction by a consumer during execution of a demand response event. For example, a consumer may reduce hundred percent expected energy usage during the first hour of execution of a demand response event. However, in the second hour of the execution of the demand response event, the consumer may show a decay of ten percent in reduction of energy usage. Therefore, the decay in reduction of energy usage of the consumer is ten percent in the second hour. The decay in reduction of energy usage may be determined based upon the historical response data.

Furthermore, the model values may include the rebound effect corresponding to each of the consumers 104, 106, 108. As used herein, the term “rebound effect” may be used to refer to a tendency of a consumer to increase energy consumption after participating in a demand response event. In one embodiment, the rebound effect may be a percentage increase in consumption of electricity by a consumer after participating in a demand response event. For example, a consumer may increase the consumption of energy by twenty percent after participating in a demand response event for washing clothes, watching tv, cleaning utensils, and the like. The rebound effect, for example, may be determined based upon the historical response data. For example, if a consumer shows a trend of increase in energy consumption by twenty percent after participation in multiple demand response events, then a value of rebound effect corresponding to the consumer may be twenty percent.

Additionally, the model values may include the temperature curve value corresponding to each of the consumers 104, 106, 108. As used herein, the term “temperature curve value” may be used to refer to a value that is assigned to each of the consumers based upon a variation in consumption of electricity by the consumer with change in temperature (or other weather and environmental factors). For example, if there is no variation in a consumer's energy usage with variation in atmospheric temperature, then the value of temperature curve may be equated to a value of one. If the consumer's energy usage increases with the temperature then the value for the temperature curve would be greater than one for each temperature that results in increased energy usage.

At step 206, the model values for each of the consumers 104, 106, 108 may be stored in the data repository 128. In certain embodiments, at step 208, the consumers' data, historical response data and the contractual obligations data may be updated. In one embodiment, the consumers' data, historical response data and contractual obligations data may be updated periodically. In another embodiment, the consumers' data, historical response data and the contractual obligations data may be updated when one or more new inputs, amendments or requests are received from one or more sources. As previously noted with reference to FIG. 1, the sources may include the utility 102, consumers 104, 106, 108, SCADA 120, EMS 118, control center 116, and the like.

FIG. 3 is a flowchart representing an exemplary method 300 for selecting appropriate consumers for execution of a demand response event, in accordance with an embodiment of the present techniques. At step 302, a request may be received for selection of appropriate consumers for execution of a demand response event. The request, for example, may be received from the electric utility 102. In one embodiment, the request accompanies a demand response event's description data. As previously noted with reference to FIG. 1, the demand response event's description data may include a start time and an end time for energy usage reduction, a total energy usage reduction expected by an electric utility, forecasted atmospheric temperature, a region for energy reduction, and the like.

At step 304, the model values (generated at step 204 in FIG. 2), consumers' data, historical response data and contractual obligations data (stored and updated in steps 202 and 208 in FIG. 2) may be retrieved. The model values, consumers' data, historical response data and contractual obligations data, for example, may be retrieved from the data repository 128 by the DRMS 130 (see FIG. 1). Subsequently at step 306, at least one parameter may be determined based upon one or more of the consumers' data, historical response data, contractual obligations data and the model values. As previously noted with reference to FIG. 1, the parameters include a potential load reduction (PLR), an adjusted potential load reduction (APLR), an adjusted cost of utilizing each of the plurality of consumers 104, 106, 108 (see FIG. 1) in a demand response event, and the like. In one embodiment, the PLR is determined utilizing one or more model values as shown in the following equation (2):

PLR(Cᵢ)(n)=AP(Cᵢ)*PU(Cᵢ)(n)*PR(Cᵢ)(n)*A(Cᵢ)(n)*TCV(T) (2)

wherein PLR(Cᵢ)(n) is a potential load reduction by a consumer Cᵢ in n^{th} hour, AP(Cᵢ) is total energy consumed by appliances of a consumer (Cᵢ), PU(Cᵢ)(n) is a predicted deviation in energy usage by the consumer Cᵢ in the n^{th} hour, PR(Cᵢ)(n) is a probability of responding to an energy usage reduction request in the n^{th} hour, and A(Cᵢ)(n) is an availability of the consumer Cᵢ in the n^{th} hour, and TCV(T) is a temperature curve value at an atmospheric temperature T. It is noted that while equation (2) shows usage of more than one model values for determination of the PLR, one or more of the model values may be used for determination of the PLR. In one example, the equation (2) may be utilized for determination of a PLR for the first hour of execution of a demand response event by a consumer. As previously noted with reference to FIG. 2, a consumer may not reduce energy usage consistently in consecutive hours of execution of a demand response event. More particularly, the consumer may show decay in energy usage reduction with lapse of time while participating in a demand response event. In such embodiment, the PLR for consecutive hours of execution of the demand response event may be determined using the following equation (3):

PLR(n+1)=PLR(n)×decay (3)

where PLR(n+1) is potential load reduction in (n+1)^{th} hour, PLR(n) is potential load reduction in n^{th} hour, decay is a percentage decrease shown in energy usage reduction by respective consumer.

Furthermore, in another embodiment, the adjusted potential load reduction (APLR) may be determined utilizing the following equation (4):

APLR(Cᵢ)=ΣPLR(Cᵢ)×EH(Cᵢ) (4)

wherein APLR(Cᵢ) is an adjusted potential load reduction corresponding to the consumer Cᵢ, EH(Cᵢ) is an event history corresponding to the consumer Cᵢ. As previously noted with reference to FIG. 2, the event history EH(Cᵢ) is a model value which is determined utilizing equation (1). In one example, the parameter “adjusted cost” may be determined utilizing the following equation (5):

ACU(Cᵢ)=PLR(Cᵢ)/Cost(Cᵢ) (5)

where ACU(Cᵢ) is an adjusted cost of utilizing a consumer Cᵢ, PLR(Cᵢ) is a potential load reduction corresponding to the consumer Cᵢ, Cost(Cᵢ) is a cost of involving the consumer Cᵢ in a demand response event. The cost of involving the consumer Cᵢ, for example, may be determined utilizing the contractual obligations data. In certain other embodiments, the rebound effect and decay values in the model values may also be used to determine the adjusted cost of utilizing a consumer Cᵢ. In such an embodiment, the Adjusted Potential load reductions would be:

APLR(Cᵢ)=ΣPLR(Cᵢ)×EH(Cᵢ)−Rebound (6)

wherein APLR(Cᵢ) is an adjusted potential load reduction corresponding to the consumer Cᵢ, PLR(Cᵢ) is potential load reduction, Rebound is the amount of load increase in subsequent periods after the DR event.

At step 308 the appropriate consumers may be selected based upon the one or more parameters. More particularly, the appropriate consumers may be selected based upon PLR, APLR and/or adjusted cost. For instance, if PLR and APLR corresponding to a consumer Cₗ are higher in comparison to that of other consumers, then the consumer Cₗ may be selected as an appropriate consumer. The consumers could be arranged in an ordered list from best to worst, for example. In step 310, each of the selected appropriate consumers may be notified for reduction of energy usage. The notification, for example, may be sent by the electric utility 102, the control center 116, the processing subsystem 130, or the like. The notification may include details of date, time, and duration for the reduction of energy usage.

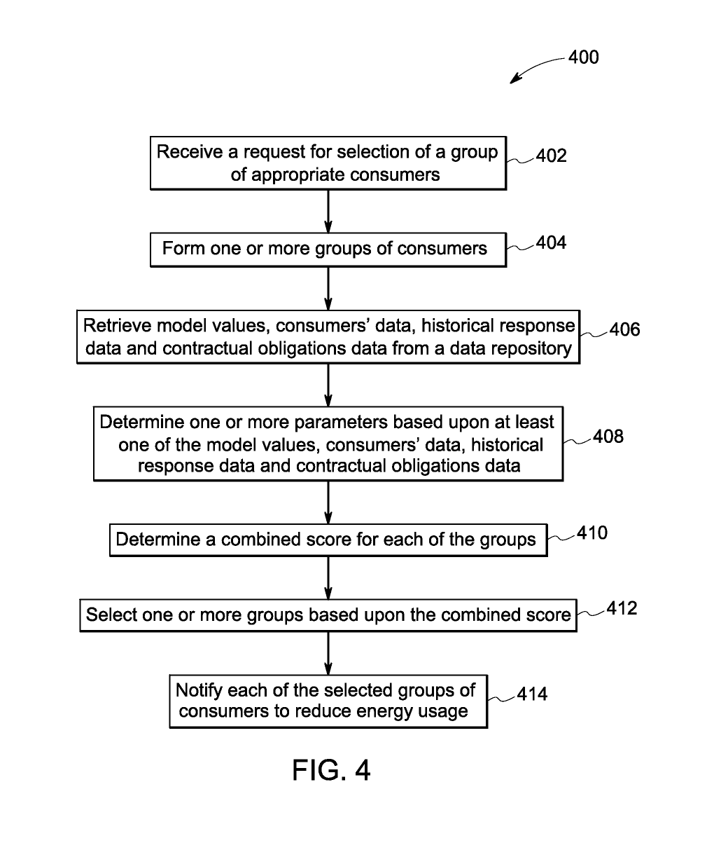

FIG. 4 is a flowchart representing an exemplary method for selecting one or more groups of appropriate consumers for execution of a demand response event, in accordance with an embodiment of the present techniques. At step 402, a request may be received for selection of a group of appropriate consumers for execution of a demand response event. More particularly, a request for selection of a group of appropriate consumers who may participate in load shedding is received. The request, for example, may be received from the electric utility 102. In one embodiment, the request accompanies a demand response event's description data. As previously noted with reference to FIG. 1, the demand response event's description data may include a start time and an end time for energy usage reduction, a total energy usage reduction expected by an electric utility, forecasted atmospheric temperature, a region for energy usage reduction, and the like.

Furthermore, at step 404, one or more groups of consumers may be formed. The consumers, for example, may include the consumers 104, 106, 108 (see FIG. 1). The groups, for example, may be formed based upon regions of the consumers, electricity usage range, type of electricity usage, and the like. At step 406, model values, consumers' data, historical response data and contractual obligations data corresponding to each of the consumers in the groups may be retrieved from the data repository 128 (see FIG. 1). As previously noted with reference to FIG. 2, the model values may be determined based upon respective consumers' data, historical response data and contractual obligations data of the consumers.

Furthermore, at step 408 one or more parameters corresponding to each of the consumers in the groups may be determined. As previously noted, the one or more parameters includes PLR, APLR and adjusted cost. The one or more parameters are determined based upon at least one of the model values, consumers' data, historical response data and contractual obligations data. The determination of the parameters has been explained with reference to step 306 in FIG. 3. Subsequently at step 410, a combined score corresponding to each of the groups (formed at step 404) may be determined. As used herein, the term “combined score” may be used to refer to a grade assigned to a group of consumers based upon one or more parameters corresponding to each of the consumers in the group. In one embodiment, the combined score corresponding to a group, for example, may be determined based upon parameters of respective consumers, total number demand response events in which the consumers participated and a total number of events in which respective consumers are expected to participate as per contractual obligations. For example, the combined score corresponding to a group G may be determined utilizing the following equation (7):

CS_{G}=Average PLR_{G}*{1−(EP/TEP)} (7)

where CS_{G} is a combined score corresponding to a group G, Average PLR_{G} is an average potential load reduction in each hour corresponding to the group G, EP is a total number of demand response events in which all the consumers in the group have participated in past and TEP is a total number of events in which all the consumers in the group G are expected to participate as per contractual obligations. The Average PLR_{G} may be determined using the following equation (8):

AvergaePLR_{Γ}=Total PLR_{G}/Total hours (8)

Average PLR_{G} is an average potential load reduction in each hour corresponding to the group G, Total PLR_{G} is a total PLR corresponding to the group G for a determined time period in a demand response event, and Total hours is a total number of hours in the demand response event.

At step 412, one or more groups may be selected based upon the combined score assigned to the groups at step 410. In one embodiment, the groups that have a higher combined score may be selected for execution of the demand response event. At step 414, each of the consumers in the selected groups may be sent a notification to reduce energy usage in a specified duration.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method, comprising:
receiving consumers' data, historical response data, contractual obligations data of a plurality of consumers;
receiving a demand response event's description data;
determining at least one parameter corresponding to each of the plurality of consumers based upon one or more of the consumers' data, the historical response data, the contractual obligations data and the demand response event's description data; and
selecting a subset of consumers from the plurality of consumers based upon the at least one parameter,
wherein the at least one parameter comprises a potential load reduction for each of the plurality of consumers.

2. The method of claim 1, further comprising receiving a request for selecting the subset of consumers to reduce energy usage in a specified duration.

3. The method of claim 1, wherein the at least one parameter further comprises an adjusted potential load reduction, and an adjusted cost corresponding to each of the plurality of consumers.

4. The method of claim 1, further comprising notifying each of the subset of consumers to reduce energy usage in a specified duration.

5. The method of claim 1, wherein the consumers' data comprises at least one of a unique identification, details of appliances, availability at a specified duration, a number of events contributed to for energy usage reduction and a probability of responding to the request for reduced energy consumption by each of the plurality of consumers.

6. The method of claim 1, wherein the historical response data comprises at least one of a date and time of sending a request for reduction of energy usage in a demand response event, a unique ID of a consumer to whom the request was sent, a date, time and duration of the demand response event, response to the request, a total number of demand response events in which the consumer participated, a rebound effect of the consumer after participating in each demand response event, a total number of demand response events in which the consumer refused to participate, and the like.

7. The method of claim 1, wherein the contractual obligations data comprises at lest one of a cost of involving each of the plurality of consumers in a demand response event, and terms and conditions in each demand response contract as entered in to by the plurality of consumers.

8. The method of claim 1, wherein the demand response event's description data comprises at least one of a start time and an end time for energy usage reduction, a potential total amount of energy usage reduction, a specified duration for energy usage reduction, forecasted atmospheric temperature, a region for energy reduction, and the like.

9. The method of claim 1, further comprising:
collecting and storing the consumers' data, the historical response data, and the contractual obligations data;
generating one or more model values corresponding to each of the plurality of consumers based upon the consumers' data, the historical response data and the contractual obligations data;
storing the one or more model values corresponding to each of the plurality of consumers; and
updating the consumers' data, the historical response data, the contractual obligations data, and the one or more model values.

10. The method of claim 9, wherein the one or model values comprises a total energy consumed by appliances of a consumer, predicted deviation in energy usage by the consumer, event history, a probability of responding to a request for reduction of energy usage, availability of the consumer, decay in reduction of energy usage by the consumer, rebound effect, temperature curve value, and the like.

11. A method, comprising:
receiving consumers' data, historical response data and contractual obligations data of a plurality of consumers;
receiving a demand response event's description data;
determining at least one parameter corresponding to each of the plurality of consumers based upon one or more of the consumers' data, the historical response data, the contractual obligations data and the demand response event's description data; and
selecting the appropriate consumers from the plurality of consumers based upon the at least one parameter,
wherein the at least one parameter comprises a potential load reduction, an adjusted potential load reduction, and an adjusted cost corresponding to each of the plurality of consumers.

12. A method, comprising:
receiving consumers' data, historical response data and contractual obligations data corresponding to each consumer in a plurality of groups of consumers;
receiving a demand response event's description data;
determining at least one parameter corresponding to each consumer in the plurality of groups of consumers based upon one or more of the consumers' data, the historical response data, the contractual obligations data and the demand response event's description data;
generating a combined score corresponding to each of the plurality of groups based upon the at least one parameter; and
selecting the group of consumers based upon the generated combined scores;
wherein each of the at least one parameter comprises a potential load reduction (PLR) for each of the plurality of consumers.

13. The method of claim 12, wherein the at least one parameter further comprises an adjusted potential load reduction (APLR), and a cost of utilizing each of the plurality of consumers to reduce the energy usage in the specified duration.

14. The method of claim 12 wherein said selecting the group of consumers comprises: selection of the one or more groups of consumers such that each group in the plurality of groups of consumers is optimally and equitably used for demand response events.

15. A system, comprising:
a network of consumers; and
a processing subsystem that:
receives a request for selecting a subset of consumers to reduce energy usage in a specified duration, and a demand response event's description data;
collects consumers' data, historical response data and contractual obligations of a plurality of consumers;
determines at least one parameter corresponding to each of the plurality of consumers based upon one or more of the consumers' data, the historical response data, the contractual obligations data, and the demand response event's description data; and
selects the subset of consumers from the plurality of consumers based upon the at least one parameter,
wherein the at least one parameter comprises a potential load reduction for each of the plurality of consumers.

16. The system of claim 15, wherein the at least one parameter further comprises an adjusted potential load reduction, and an adjusted cost corresponding to each of the plurality of consumers.

17. The system of claim 15, wherein the processing subsystem periodically updates the consumers' data, the historical response data and the contractual obligations data.

18. The system of claim 15, further comprising a data repository that stores the consumers' data, the contractual obligations data, the historical response data, the demand response event's description data and any transient data.

19. The system of claim 15, further comprising an electric utility that sends the request for selecting the subset of consumers to reduce energy usage in a specified duration, and the demand response event's description data.

20. A system, comprising:
a network of consumers;
a processing subsystem that:
receives a request for selecting the appropriate consumers to reduce energy usage in a specified duration, and a demand response event's description data;
collects consumers' data, historical response data and contractual obligations data of a plurality of consumers;
determines at least one parameter corresponding to each of the plurality of consumers based upon one or more of the consumers' data, the historical response data, the contractual obligations, and the demand response event's description data; and
selects the appropriate consumers from the plurality of consumers based upon the at least one parameter,
wherein the at least one parameter comprises a potential load reduction for each of the plurality of consumers.

21. A non-transitory computer readable medium with a program to instruct a computer to:
receive consumers' data, historical response data, contractual obligations data of a plurality of consumers;
receive a demand response event's description data;
determine at least one parameter corresponding to each of the plurality of consumers based upon one or more of the consumers' data, the historical response data, the contractual obligations data and the demand response event's description data; and
select a subset of consumers from the plurality of consumers based upon the at least one parameter,
wherein the at least one parameter comprises a potential load reduction for each of the plurality of consumers.
